(19) United States
(12) Patent Application Publication
(10) Pub. No.: US 2025/0138802 A1
(43) Pub. Date: May 1, 2025

(54) SYSTEM AND METHOD TO BUILD AN IMAGE USING SCRIPTS AND OPENBMC FOR MULTIPLE HARDWARE PLATFORMS

(71) Applicant: Vertiv Corporation, Westerville, OH (US)

(72) Inventors: PRASHANT VISHNU BHUMKAR, Pune (IN); SHIVRAJ NANASAHEB TORAVI, Solapur (IN)

(21) Appl. No.: 18/931,996

(22) Filed: Oct. 30, 2024

(30) Foreign Application Priority Data
Oct. 31, 2023 (IN) 202321074241

(51) Int. Cl. G06F 8/61; G06F 9/445

(52) U.S. Cl. CPC G06F 8/63; G06F 9/44505

(57) ABSTRACT

A method includes receiving a plurality of scripts and selecting, based on at least some of the plurality of scripts and from a plurality of System-on-a-Chip (SoC) configurations, an SoC configuration configured to build an image. The method also includes receiving a custom configuration script file corresponding to the selected SoC configuration, and transmitting the custom configuration script file to at least one hardware board of a plurality of hardware boards. The at least one hardware board may be compatible with the custom configuration script file. The method also includes constructing, an environment generated based on the at least one hardware board an image for the selected SoC.

### CROSS REFERENCE TO RELATED APPLICATIONS

This U.S. Non-Provisional patent application claims the benefit of Indian Provisional Patent Application No. 2023210742413 titled “System And Method To Build An Image Using Scripts And OpenBMC For Multiple Hardware Platforms” filed Oct. 31, 2023, the entire disclosure of which is hereby incorporated by reference.

### TECHNICAL FIELD

The present disclosure relates, in general, to the field of computer science. More particularly, embodiments of the invention relate to a system and a method to build an image using scripts and openBMC (open baseboard management controller) for multiple hardware platforms.

### BACKGROUND

The background information herein below relates to the present disclosure but is not necessarily prior art.

Custom images refer to graphics or visuals that are specifically created or tailored to meet the unique requirements, preferences, or specifications of a particular project, individual, or organization. These images are not generic or readily available; instead, they are designed or commissioned with specific purposes in mind.

Custom images hold the power to set businesses apart in a crowded market, allowing them to establish a strong and memorable visual identity. They are also cherished in personal contexts, serving as cherished mementos, gifts, or decorations that reflect individual tastes and stories. By harnessing the creativity and expertise of artists and designers, custom images transform ideas and concepts into tangible and visually striking realities, making them invaluable tools for communication, expression, and connection in a visually oriented world.

In recent years, the open computing environment has witnessed significant growth and transformation, with a strong emphasis on flexibility, customization, and efficiency. Customers operating in this evolving landscape have expressed a compelling need for a solution that empowers them to create custom images tailored to various hardware platforms.

The primary issue at hand is the demand from customers for a solution that facilitates the creation of customized images for a diverse range of hardware platforms. This requirement arises from the ever-evolving open computing environment, where the ability to adapt quickly to changing hardware configurations is paramount.

Therefore, there is a need to develop a system and method to build an image for multiple hardware platforms that can alleviate the aforementioned drawbacks.

### SUMMARY

An aspect of the disclosed embodiments includes a method that includes receiving a plurality of scripts and selecting, based on at least some of the plurality of scripts and from a plurality of System-on-a-Chip (SoC) configurations, a SoC configuration configured to build an image. The method also includes receiving a custom configuration script file corresponding to the selected SoC configuration, and transmitting the custom configuration script file to at least one hardware board of a plurality of hardware boards. The at least one hardware board may be compatible with the custom configuration script file. The method also includes constructing, an environment generated based on the at least one hardware board an image for the selected SoC.

Another aspect of the disclosed embodiments includes a system. The system includes a processor and a memory. The memory includes instructions that, when executed by the processor, cause the processor to: receive a plurality of scripts; select, based on at least some of the plurality of scripts and from a plurality of System-on-a-Chip (SoC) configurations, an SoC configuration configured to build an image; receive a custom configuration script file corresponding to the selected SoC configuration; transmit the custom configuration script file to at least one hardware board of a plurality of hardware boards, wherein the at least one hardware board is compatible with the custom configuration script file; and construct, an environment generated based on the at least one hardware board an image for the selected SoC.

Another aspect of the disclosed embodiments includes an apparatus. The apparatus includes a computing device configured to: receive a plurality of scripts; select, based on at least some of the plurality of scripts and from a plurality of System-on-a-Chip (SoC) configurations, an SoC configuration configured to build an image; receive, an open baseboard management controller, a custom configuration script file corresponding to the selected SoC configuration; transmit the custom configuration script file to at least one hardware board of a plurality of hardware boards, wherein the at least one hardware board is compatible with the custom configuration script file; construct, an environment generated based on the at least one hardware board an image for the selected SoC; and flash the image on to the selected SoC.

Other objects and advantages of the present disclosure will be more apparent from the following description when read in conjunction with the accompanying figures, which are not intended to limit the scope of the present disclosure.

### BRIEF DESCRIPTION OF THE ACCOMPANYING DRAWING

A system and method to build an image using scripts and openBMC (open baseboard management controller) for multiple hardware platforms of the present disclosure will now be described with the help of the accompanying drawing, in which:

FIG. 1 illustrates an exemplary block diagram of a system to build an image using scripts and openBMC for multiple hardware platforms;

FIG. 2 illustrates an architecture of a system to build an image using scripts and openBMC for multiple hardware platforms; and

FIG. 3 illustrates a method to build an image using scripts and openBMC for multiple hardware platforms, in accordance with an embodiment of the present disclosure.

### DETAILED DESCRIPTION

Reference will now be made in detail to example embodiments which are illustrated in the accompanying drawings, wherein like reference numerals refer to like elements throughout. In this regard, the example embodiments may have different forms and may not be construed as being limited to the descriptions set forth herein.

It will be understood that the terms “include,” “including,” “comprise,” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be further understood that, although the terms “first,” “second,” “third,” etc., may be used herein to describe various elements, components, regions, layers and/or sections, these elements, components, regions, layers and/or sections may not be limited by these terms. These terms are only used to distinguish one element, component, region, layer or section from another element, component, region, layer or section.

As used herein, the term “and/or” includes any and all combinations of one or more of the associated listed items. Expressions such as “at least one of,” when preceding a list of elements, modify the entire list of elements and do not modify the individual elements of the list.

Various terms are used to refer to particular system components. Different companies may refer to a component by different names—this document does not intend to distinguish between components that differ in name but not function.

Matters of these example embodiments that are obvious to those of ordinary skill in the technical field to which these example embodiments pertain may not be described herein in detail.

It may be understood that the example embodiments described herein may be considered in a descriptive sense only and not for purposes of limitation. Descriptions of features or aspects within each example embodiment may be considered as available for other similar features or aspects in other example embodiments.

Custom images refer to graphics or visuals that are specifically created or tailored to meet the unique requirements, preferences, or specifications of a particular project, individual, or organization. These images are not generic or readily available; instead, they are designed or commissioned with specific purposes in mind.

In recent years, the open computing environment has witnessed significant growth and transformation, with a strong emphasis on flexibility, customization, and efficiency. Customers operating in this evolving landscape have expressed a compelling need for a solution that empowers them to create custom images tailored to various hardware platforms.

Accordingly, the systems and methods described in the present disclosure have embarked on an innovative journey by adopting OpenBMC to address this pressing challenge. The systems and methods described herein may be configured to leverage the capabilities of OpenBMC to build custom images through the use of custom scripts and within the OpenBMC environment, or any suitable environment.

The present disclosure envisages a system and a method to build an image using scripts and openBMC for multiple hardware platforms. The systems and methods described herein may be configured to provide a streamlined process for creating custom images using OpenBMC within the open computing environment. The systems and methods described herein may be configured to use the configuration of System-on-Chip (SoC) hardware, image building, and the efficient deployment of these images onto target hardware. The systems and methods described herein may be configured to provide a comprehensive solution for both Linux PCs and specific hardware platforms, such as open19 hardware and Raspberry Pi.

The OpenBMC project is a Linux Foundation collaborative open-source project whose goal is to produce an open source implementation of the baseboard management controllers (BMC) firmware stack. OpenBMC is a Linux distribution for BMCs meant to work across heterogeneous systems that include enterprise, high-performance computing (HPC), telecommunications, and cloud-scale data centers.

The OpenBMC utilizes D-Bus as an IPC mechanism, making it easier to integrate with other software components and systems. This facilitates smooth communication and data exchange between different parts of your infrastructure. OpenBMC includes a built-in web server (bmcweb) for the backend and a web user interface (WebUI) for the front end. This out-of-the-box web-based management capability simplifies remote monitoring and control of hardware resources.

Unlike closed BMC solutions that are locked to the features provided by the manufacturer, OpenBMC is highly customizable. Users can tailor it to their specific requirements, adding or modifying features as needed to meet their unique management needs.

The present disclosure described herein above has several technical advantages including, but not limited to, a system 100 and a method 400 to build an image using scripts and openBMC (open baseboard management controller) for multiple hardware platforms. In some embodiments, the systems and methods described herein may be configured to provide user(s) with a system using OpenBMC that seamlessly integrates with cloud-scale data centers. The systems and methods described herein may be configured to provide user(s) with a system using OpenBMC that aligns with future technology trends, including IoT (Internet of Things).

The systems and methods described herein may be configured to improve time-efficiency, by utilizing custom recipe files within the OpenBMC environment, which may streamline the image creation process, resulting in faster product development and deployment (e.g., which may significantly reduce the time required to build images for different hardware platforms. The systems and methods described herein may be configured to provide compatibility across hardware platforms, (e.g., OpenBMC is adaptable to a wide range of hardware platforms).

The systems and methods described herein may be configured to provide versatility by using the same software across various devices, saving resources and effort in developing separate management solutions for each hardware variant. The systems and methods described herein may be configured to provide adaptability to IoT requirements. The systems and methods described herein may be configured to provide a forward-looking solution for managing IoT devices and sensors. The systems and methods described herein may be configured to be relatively cost-effective, with the ability to customize features and adapt the solution to specific needs, reducing costs associated with proprietary BMC solutions by avoiding unnecessary licensing fees and vendor lock-in.

The systems and methods described herein may be configured to ameliorate one or more problems of the prior art or to at least provide a useful alternative. The systems and methods described herein may be configured to build an image using scripts and openBMC for multiple hardware platforms. The systems and methods described herein may be configured to build an image that ensures efficient and tailored image creation. The systems and methods described herein may be configured to build an image that offers versatile deployment methods, including SD Card, serial, and Ethernet connections.

The systems and methods described herein may be configured to build an image designed to work optimally with the selected SoC and hardware. The systems and methods described herein may be configured to build an image to provide unified hardware management solutions that simplify device-agnostic hardware management tasks. The systems and methods described herein may be configured to build an image that offers extensive customization options, empowering users to tailor BMC solutions to their specific requirements. The systems and methods described herein may be configured to build an image that allow users to adapt the BMC environment to suit their unique needs, reducing vendor dependence.

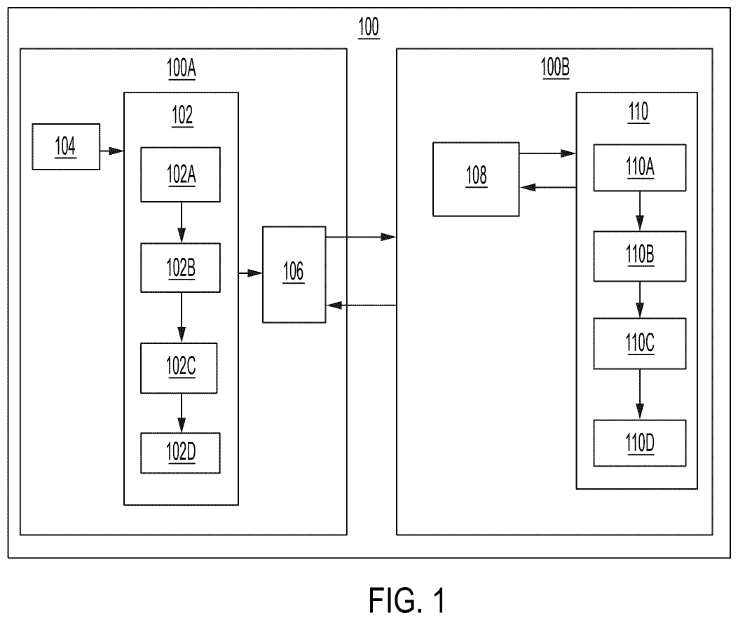

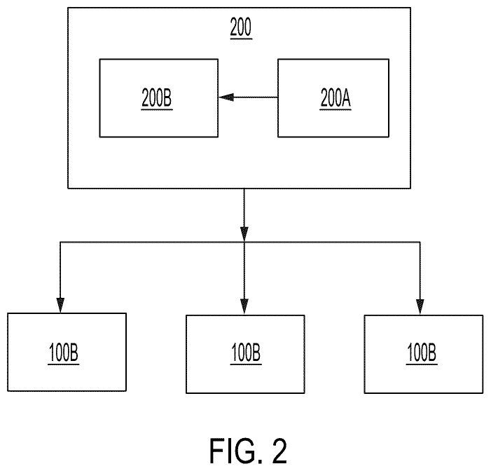

With reference to FIGS. 1 and 2, a system 100 may be configured to build an image using scripts and openBMC for multiple hardware platforms. FIG. 1 illustrates an exemplary block diagram of the system 100 to build an image using scripts and openBMC for multiple hardware platforms.

The system 100 includes an openBMC 100A, and a plurality of hardware boards 100B. In some embodiments, the openBMC 100A includes a processor 102, a memory 104, and a peripheral interface 106. The memory 104 may be configured to store an openBMC environment 200 which is obtained by cross-compiling of an openBMC software framework. The processor 102 may be configured to execute the openBMC environment 200 stored in the memory 104 using one or more processing modules. The one or more processing modules include a receiving module 102A, a selection module 102B, a generation module 102C, and a transmission module 102D.

The receiving module 102A may be configured to receive a plurality of scripts 200A to select a SoC. The selection module 102B may be configured to select a SoC for building an image. The generation module 102C may be configured to create a custom configuration script file 200B tailored for the selected SoC, where the custom configuration script is created based on a modified recipe associated with a compatible hardware board 100B. The transmission module 102D may be configured to receive the custom configuration script file and transmit the custom configuration script file to at least one of a plurality of hardware boards 100B using a communication network link (SD card, serial, or Ethernet), where the at least one of the plurality of hardware boards 100B is compatible with the generated scripts.

In some embodiments, each of the plurality of hardware boards 100B may include a data storage device 108, and a processor 110. The data storage device 108 may be configured to store a set of pre-defined instructions, a set of processing rules, and a plurality of data related to multiple hardware boards 100B. The processor 110 is communicatively coupled to the data storage device 108 to execute one or more processing modules using the set of predefined instructions for implementing an image building process for multiple hardware boards 100B.

The processor 110 may be implemented as one or more microprocessors, microcomputers, microcontrollers, digital signal processors, central processing units, logic circuitries, and/or any devices that manipulate data based on operational instructions. Among other capabilities, the processor 110 is configured to communicate with the data storage device 108 and execute the one or more predefined instructions stored in the data storage device 108 for implementing an image building process for multiple hardware boards 100B. The processor 110 may be implemented as a combination of hardware and programming (for example, programmable instructions) to implement one or more functionalities of the processor 110. In the examples described herein, such combinations of hardware and programming may be implemented in several different ways. For example, the programming for the processor 110 may be processor-executable instructions stored on a non-transitory machine-readable storage medium and the hardware for the processor 110 may include a processing resource (for example, one or more processors), to execute such instructions.

In the present examples, the machine-readable storage medium may store instructions that, when executed by the processing resource, implement the ASD prediction process in a subject. In such examples, the processor 110 may include the machine-readable storage medium storing the instructions and the processing resource to execute the instructions, or the machine-readable storage medium may be separate but accessible to the system 100 and the processing resource. In other examples, the processor 110 may be implemented by electronic circuitry.

In some embodiments, the one or more processing modules may include a receiving module 110A, a configuration module 110B, a construction module 110C, and an assigning module 110D. The receiving module 110A may be configured to receive the custom configuration script file 200B from the openBMC.

The configuration module 110B may be configured to receive the custom configuration script file 200B to set up an environment 200 based on the compatible hardware board 100B to accommodate the custom configuration script file 200B and accommodate the custom configuration script file 200B in the configured environment 200 for ensuring a seamless integration process.

The construction module 110C may be configured to construct the image for the selected SoC incorporating essential elements like the bootloader (u-boot), Linux kernel, open-source packages, and specialized board-specific packages, based on the custom configuration script file 200B.

The assigning module 110D may be configured to deploy the constructed image onto the compatible hardware board 100B, and flash the constructed image on the selected SoC.

In some embodiments, the custom configuration script file are written and modified for open19 controller and raspberry pi hardware to build image using openBMC.

In some embodiments, both the bootloader and the Linux kernel include a plurality of hardware drivers for the BMC SoC, including an i2c driver, USB driver, PWM driver, and SPI driver.

In some embodiments, the open-source packages include common applications such as Busy Box, i2c-tools, lm-sensors, OpenSSH, and Python.

In some embodiments, the specialized board-specific packages include initialization scripts and a plurality of tools for a specific hardware board.

In some embodiments, a plurality of tools includes a tool to dump asset info from the EEPROM and a fan-controller daemon to control the fan speed based on OpenBMC environment 200 readings.

In some embodiments, all the open-source packages and the specialized board-specific packages in OpenBMC are built from a source by using a Yocto Project.

In some embodiments, the Yocto Project forms the software packages that are grouped together into a plurality of recipes and the plurality of recipes are grouped together into three layers.

In some embodiments, the three layers are a common layer, a SoC layer, and a board layer.

In some embodiments, the common layer includes the packages that are used in different boards and BMC SoCs.

In some embodiments, the SoC layer includes packages specific to BMC SoCs, both the bootloader and the kernel are defined in the SoC layer. In an aspect, the board layer includes packages for different boards.

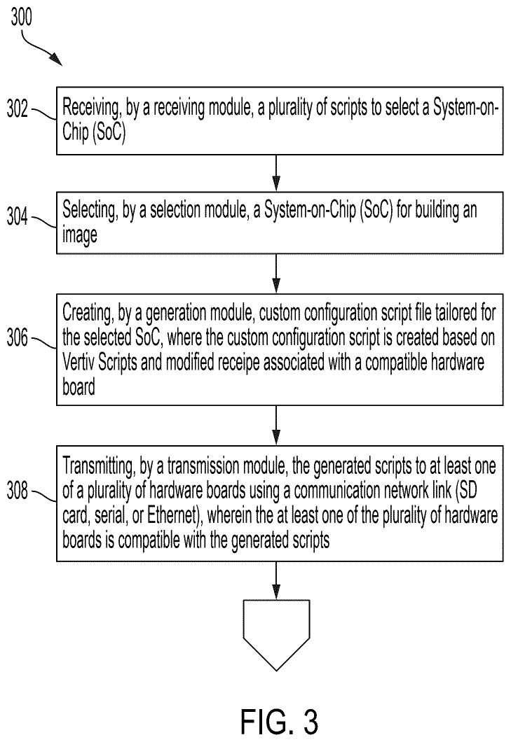

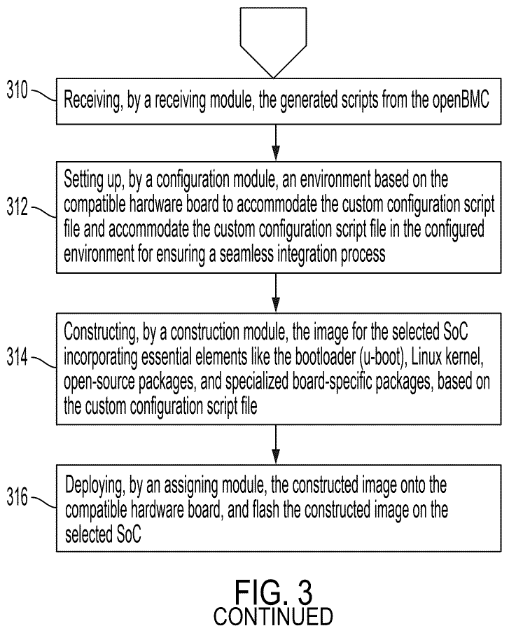

The present disclosure further describes a method 300 to build an image using scripts and openBMC for multiple hardware platforms and is described with reference to FIG. 3. The order in which the method 300 is described is not intended to be construed as a limitation, and any number of the described method steps can be combined in any appropriate order to carry out the method 300 or an alternative method. Additionally, individual steps may be deleted from the method 300 without departing from the scope of the subject matter described herein. The method to build an image using scripts and openBMC for multiple hardware platforms performs by an openBMC. The method 300 includes the following steps:

In method step 302, the method 300 comprises receiving, by a receiving module 102A, a plurality of scripts 200A to select a SoC.

In method step 304, the method 300 comprises selecting, by a selection module 102B, a SoC for building an image.

In method step 306, the method 300 comprises creating, by a generation module 102C, custom configuration script file 200B tailored for the selected SoC, where the custom configuration script 200B is created based a modified recipe associated with a compatible hardware board 100B.

In method step 308, the method 300 comprises transmitting, by a transmission module 102D, the custom configuration script file 200B to at least one of a plurality of hardware boards 100B using a communication network link (SD card, serial, or Ethernet), where the at least one of the plurality of hardware boards 100B is compatible with the generated scripts.

In method step 310, the method 300 comprises receiving, by a receiving module 110A, the custom configuration script file 200B from the openBMC.

In method step 312, the method 300 comprises setting up, by a configuration module 110B, an environment 200 based on the compatible hardware board 100B to accommodate the custom configuration script file 200B and accommodate the custom configuration script file 200B in the configured environment 200 for ensuring a seamless integration process.

In method step 314, the method 300 comprises constructing, by a construction module 110C, the image for the selected SoC incorporating essential elements like the bootloader (u-boot), Linux kernel, open-source packages, and specialized board-specific packages, based on the custom configuration script file 200B.

In method step 316, the method 300 comprises deploying, by an assigning module 110D, the constructed image onto the compatible hardware board 100B, and flash the constructed image on the selected SoC.

The foregoing description of the embodiments has been provided for purposes of illustration and is not intended to limit the scope of the present disclosure. Individual components of a particular embodiment are generally not limited to that particular embodiment but, are interchangeable. Such variations are not to be regarded as a departure from the present disclosure, and all such modifications are considered to be within the scope of the present disclosure.

The embodiments herein and the various features and advantageous details thereof are explained with reference to the non-limiting embodiments in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The foregoing description of the specific embodiments so fully reveals the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

The use of the expression “at least” or “at least one” suggests the use of one or more elements or ingredients or quantities, as the use may be in the embodiment of the disclosure to achieve one or more of the desired objects or results.

Any discussion of documents, acts, materials, devices, articles or the like that has been included in this specification is solely for the purpose of providing a context for the disclosure. It is not to be taken as an admission that any or all of these matters form a part of the prior art base or were common general knowledge in the field relevant to the disclosure as it existed anywhere before the priority date of this application.

The numerical values mentioned for the various physical parameters, dimensions or quantities are only approximations and it is envisaged that the values higher/lower than the numerical values assigned to the parameters, dimensions or quantities fall within the scope of the disclosure, unless there is a statement in the specification specific to the contrary.

While considerable emphasis has been placed herein on the components and component parts of the preferred embodiments, it will be appreciated that many embodiments can be made and that many changes can be made in the preferred embodiments without departing from the principles of the disclosure. These and other changes in the preferred embodiment as well as other embodiments of the disclosure will be apparent to those skilled in the art from the disclosure herein, whereby it is to be distinctly understood that the foregoing descriptive matter is to be interpreted merely as illustrative of the disclosure and not as a limitation.

What is claimed is:

1. A method comprising:
receiving a plurality of scripts;
selecting, based on at least some of the plurality of scripts and from a plurality of System-on-a-Chip (SoC) configurations, an SoC configuration configured to build an image;
receiving a custom configuration script file corresponding to the selected SoC configuration;
transmitting the custom configuration script file to at least one hardware board of a plurality of hardware boards, wherein the at least one hardware board is compatible with the custom configuration script file; and
constructing, an environment generated based on the at least one hardware board an image for the selected SoC.

2. The method of claim 1, wherein the image of the selected SoC incorporates essential elements of the selected SoC.

3. The method of claim 2, wherein the essential elements include at least a bootloader, a kernel, an open-source package, and a specialized board-specific package.

4. The method of claim 2, wherein the custom configuration script file indicates the essential elements of the selected SoC.

5. The method of claim 1, wherein the custom configuration script is generated based on a modified recipe associated with the at least one hardware board.

6. The method of claim 1, wherein the custom configuration script file is received from an open baseboard management controller.

7. The method of claim 1, further comprising deploying the image onto the at least one hardware board.

8. The method of claim 7, further comprising, flashing the image on to the selected SoC.

9. A system comprising:
a processor; and
a memory including instructions that, when executed by the processor, cause the processor to:
receive a plurality of scripts;
select, based on at least some of the plurality of scripts and from a plurality of System-on-a-Chip (SoC) configurations, an SoC configuration configured to build an image;
receive a custom configuration script file corresponding to the selected SoC configuration;
transmit the custom configuration script file to at least one hardware board of a plurality of hardware boards, wherein the at least one hardware board is compatible with the custom configuration script file; and
construct, an environment generated based on the at least one hardware board an image for the selected SoC.

10. The system of claim 9, wherein the image of the selected SoC incorporates essential elements of the selected SoC.

11. The system of claim 10, wherein the essential elements include at least a bootloader, a kernel, an open-source package, and a specialized board-specific package.

12. The system of claim 11, wherein the custom configuration script file indicates the essential elements of the selected SoC.

13. The system of claim 9, wherein the custom configuration script is generated based on a modified recipe associated with the at least one hardware board.

14. The system of claim 9, wherein the custom configuration script file is received from an open baseboard management controller.

15. The system of claim 9, wherein the instructions further cause the processor to deploy the image onto the at least one hardware board.

16. The system of claim 15, wherein the instructions further cause the processor to flash the image on to the selected SoC.

17. An apparatus comprising:
a computing device configured to:
receive a plurality of scripts;
select, based on at least some of the plurality of scripts and from a plurality of System-on-a-Chip (SoC) configurations, an SoC configuration configured to build an image;
receive, an open baseboard management controller, a custom configuration script file corresponding to the selected SoC configuration;
transmit the custom configuration script file to at least one hardware board of a plurality of hardware boards, wherein the at least one hardware board is compatible with the custom configuration script file;
construct, an environment generated based on the at least one hardware board an image for the selected SoC; and
flash the image on to the selected SoC.

18. The system of claim 17, wherein the image of the selected SoC incorporates essential elements of the selected SoC.

19. The system of claim 17, wherein the essential elements include at least a bootloader, a kernel, an open-source package, and a specialized board-specific package.

20. The system of claim 19, wherein the custom configuration script file indicates the essential elements of the selected SoC.
